(19) United States
(12) Patent Application Publication
(10) Pub. No.: US 2013/0056944 A1
(43) Pub. Date: Mar. 7, 2013

(54) Magnetic Eddy Current Speed Retarding System and Wheeled Conveyance

(71) Applicants: George G. Dewey, Kildeer, IL (US); Christopher J. Norman, West Dundee, IL (US); Sigismund G. Paul, Hanover, IL (US)

(72) Inventors: George G. Dewey, Kildeer, IL (US); Christopher J. Norman, West Dundee, IL (US); Sigismund G. Paul, Hanover, IL (US)

(73) Assignee: Amber Engineering and Manufacturing Company, Inc., Elk Grove Village, IL (US)

(21) Appl. No.: 13/223,744

(22) Filed: Sep. 1, 2011

(51) Int. Cl. B60T 8/32; F16D 59/00; B60T 7/12; H02K 49/04

(52) U.S. Cl. 280/87.01; 310/105; 188/181 R

(57) ABSTRACT

A magnetic braking, governing, or speed retarding system for use with a wheeled conveyance may take advantage of eddy currents induced when a magnet moves past a non-magnetic conductor. A plurality of magnets may be disposed within a rotor that rotates as a wheel axle rotates. The magnets rotate past one or more relatively stationary stators to generate eddy currents that create a resistance on the rotor, thereby acting to retard or slow the rotational speed of the rotor and the axle. The system may be particularly well-suited with a wheeled conveyance such as a sled that is gravity driven and travels downhill along a track. The speed governing system may apply lesser force in relatively flat sections of the track, due to slower wheel rotational speeds, and greater force as the conveyance attempts to pick up speed, e.g., in steeper sections.

### BACKGROUND OF THE INVENTION

1. Field of the Invention

The present invention is directed generally to the fields of magnetic speed retarding or braking systems using eddy currents and conveyances incorporating such systems.

2. Description of the Related Art

Wheeled conveyances such as sleds can attain high speeds when traveling downhill. Oftentimes, these conveyances travel along a course defined by a track that makes a series of turns as the track winds from the start towards a finish line. As the conveyance moves along the track, it may increase or decrease in speed due to factors such as decline angle, the presence and frequency of turns or bends, the user's weight, etc.

The conveyances typically include brakes in order to stop the conveyance at the bottom of the track and to slow the conveyance at other points along the track. Traditionally, these speed retarding systems used on these conveyances have been mechanical or hydraulic in nature. Some systems apply braking forces automatically, while others require that the user applies the force manually in order to slow down the conveyance. These systems also may be affected negatively by moisture and dirt by reducing their effectiveness, increasing wear, and decreasing their useful lives.

With manual systems, if the brakes are applied too late, the user may reach a high rate of speed that prevents him from fully controlling the conveyance. Conversely, too large of a braking force may be applied when it is not necessary, such as during flatter portions of the track. If this happens, the conveyance may decelerate to such a slow speed that it may be difficult to get the conveyance moving again. Additionally, mechanical brakes may lock, requiring the user to repair or replace the brakes in order to use the sled again. Mechanical brakes also may include elements such as brake pads that wear down with repeated braking and require routine maintenance and replacement, which increases down-time during which the conveyance cannot be used and also increases the cost to own and operate the conveyance.

Some hydraulic brakes may lose braking effect at increased speeds. Thus, in those hydraulic braking systems, the user may experience undesirable braking effects at both high and low speeds. For example, the conveyance may not brake sufficiently at high speeds when the user desires more braking force, while it may brake too much at slower speeds, stopping or unacceptably slowing the user nearing the start of the run or during relatively flat portions of the run. In addition, regardless of whether braking increases or decreases with these hydraulic systems, hydraulic brakes also suffer from potential leaks of hydraulic fluid, which require additional downtime and increased cost for maintenance and repair, as well as clean-up of the conveyance, the track, and the user.

Other conveyances may rely on centrifugal braking systems to help retard speed. These systems often result in the wheels locking up and skidding when braking pressure is applied, which may cause deformation such as flattening of the portion of the wheels in contact with the ground. As the deformation grows, the wheels may have a tendency to rest in the worn out portions as more skidding occurs, further wearing out the wheels. This may result in a bumpier ride for the user and the need to replace the wheels more frequently.

What is needed is a speed retarding system that overcomes these drawbacks.

### SUMMARY OF THE INVENTION

A system for retarding the speed of a conveyance by applying a decelerating torque, i.e., a torque opposite in direction to the rotating direction. Depending on the speed and accelerating forces applied on the conveyance, the system may slow the conveyance or lessen the increase in speed of the conveyance.

In one aspect, a magnetic speed governing device may include an axle coupled to at least one wheel, a rotor coupled to and configured to rotate with the axle, a stator coaxial with the axle and configured to not rotate with the axle, and a gap between the rotor and stator. The device also may include a second stator coaxial with the axle on the opposite side of the rotor as the first stator. At least one of the rotor and stator may include a magnetic material, and the other may be a non-magnetic, highly conductive material. Preferably, the magnetic material may be in the rotor and may comprise a plurality of magnets substantially similarly radially spaced from an axis of the axle. The magnets may have alternating polarities and may extend substantially from one side of the rotor to the other.

The governing device also may include a second rotor coupled to a second axle, the second axle coupled to a second wheel, and a second stator coaxial with the second axle and configured to not rotate with the second axle. At least one of the second rotor and second stator may include a magnetic material, and the other may include a non-magnetic, highly conductive material (although not necessarily in the same configuration as the first rotor and stator). Here, the first and second axles may be different from one another, even though the first wheel may be on one side of a conveyance and the second wheel may be on an opposite side of said conveyance, e.g., it could be possible for two rear wheels to have separate axles.

In another aspect, a magnetic speed retarding system may include a rotor rotatable on an a shaft, the rotor having a first face and a second face that may be generally perpendicular to an axis of rotation, the rotor including a plurality of magnets. The system also may include a first stationary element generally perpendicular to and spaced a first distance from the first face and a second stationary element generally perpendicular to and spaced a second distance from the second face, the first and second distances being substantially equal. The stationary elements may comprise non-magnetic, highly conductive materials, and each may have a radial extent measured from the axis of rotation that is greater than a radial extent of the rotor.

The magnets may be substantially equally circumferentially spaced about the rotor's axis of rotation, and each magnet may have a diameter of about ½″. The magnets also may have alternating polarities, i.e., if one magnet has a positive polarity in one direction, an adjacent magnet has a negative polarity in that direction. Magnets preferably are permanent magnets such as rare earth magnets, e.g., neodymium magnets.

In still another aspect, a wheeled conveyance including a magnetic retarding system may comprise a frame, a plurality of wheels coupled to at least one axle, a bracket coupled to the frame for operably coupling the axle to the frame, a rotor configured to rotate as one of the axles rotates, a stator operably coupled to the frame and configured to not rotate as the axles rotates, and a plurality of magnets disposed within said rotor and spaced generally equally circumferentially about an axis of rotation of said rotor. The stator may be a non-magnetic, highly conductive material, and the rotor and stator may be separated by an air-filled gap, which may be generally planar and may have a generally constant thickness. Additionally, the conveyance may include a mechanical brake.

The conveyance also may include a second stator operably coupled to the frame, and the first and second stators may be on opposite sides of the rotor. Here, the magnets may be disposed substantially completely through the rotor, so that a single magnet may act on both stators.

The bracket that operably couples the axle to the frame also may include a spanning portion extending width-wise across at least a portion of the frame, an arm extending generally perpendicular to the spanning portion and generally length-wise across at least a portion of the frame, and an axle mount extending generally parallel to and away from the arm, said axle mount including an opening through which said one of said at least one axles is disposed. In addition, the stator also may be fixedly coupled to the bracket.

These and other features and advantages are evident from the following description, with reference to the accompanying drawings.

### BRIEF DESCRIPTION OF THE SEVERAL VIEWS OF THE DRAWINGS

FIG. 1 is a perspective view of a conveyance that may include a magnetic speed retarding or governing system.

FIG. 2 is a rear view of a conveyance including a magnetic speed retarding or governing system.

FIG. 3 is a detail view of the magnetic speed retarding or governing system of FIG. 1.

FIG. 4 is a side, detail view of a rotor and stator used with the speed retarding or governing system of FIG. 1.

FIG. 5 is a rear view of a conveyance including a second embodiment of a magnetic speed retarding or governing system.

FIG. 6 is a side view of another configuration of magnets disposed in a speed retarding system.

FIG. 7 is a side view of still another configuration of magnets disposed in a speed retarding system.

FIG. 8 is a rear, section view of another embodiment of a magnetic speed retarding or governing system.

FIG. 9 is a side view of another embodiment of a reaction plate, which may be a rotor or stator and may be used in combination with a magnetic disc.

FIG. 10 is a section view of a combination of a pair of the reaction plates of FIG. 9 and a magnetic disc, taken through section 10-10 in FIG. 9.

FIG. 11 is a side view of another embodiment of a magnetic disc, which may be a rotor or stator and may be used in combination with a reaction plate.

FIG. 12 is a side view of yet another embodiment of a magnetic disc, which may be a rotor or stator and may be used in combination with a reaction plate.

FIG. 13 is a side, section view of an alternative embodiment of a magnetic speed retarding or governing system.

FIG. 14 is a rear, section view of another alternative embodiment of a magnetic speed retarding or governing system.

FIG. 15 is a rear, section view of still another alternative embodiment of a magnetic speed retarding or governing system.

FIG. 16 is a graph showing the relationship between radial distance for the magnets and retarding torque as a function of rotational rate.

FIG. 17 is a graph showing the relationship between the number of magnets and retarding torque as a function of rotational rate.

### DETAILED DESCRIPTION OF THE INVENTION

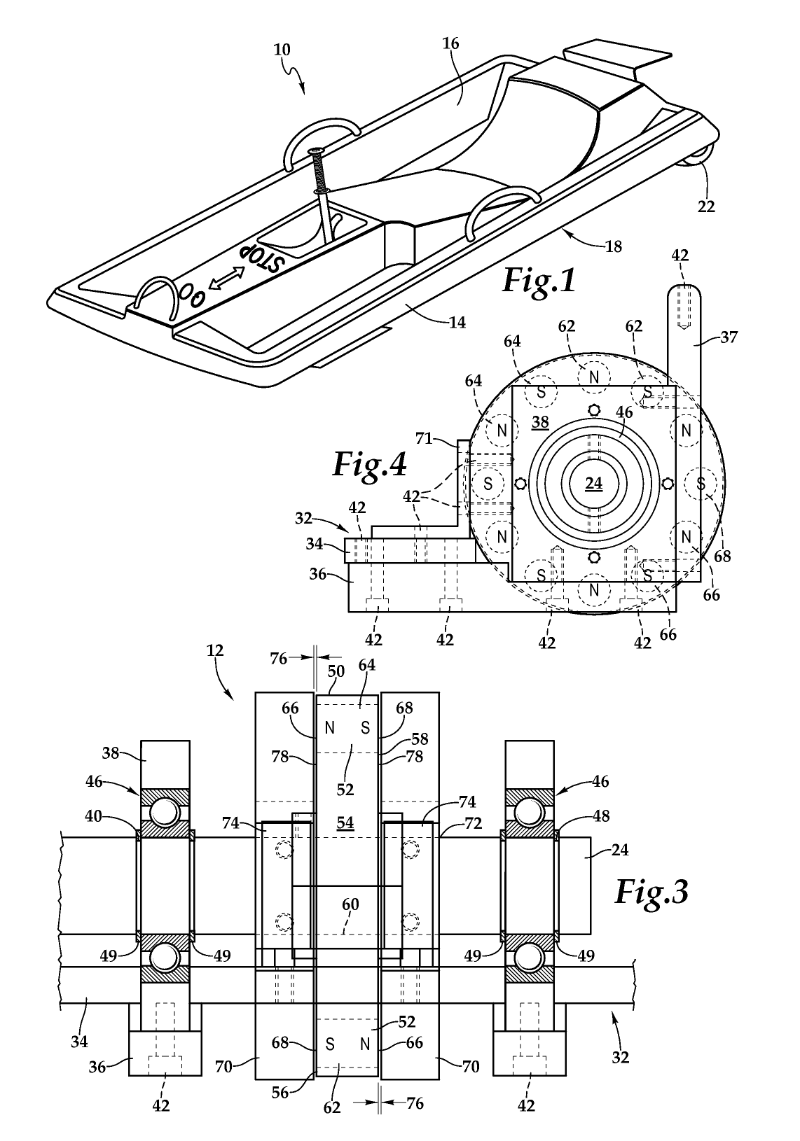

As described herein, a magnetic speed retarding system 12 uses an induced eddy current to govern and/or brake a conveyance 10. As seen in FIG. 1, conveyance 10 may be of a type that rolls downhill within a track 2. Here, conveyance 10 also may be called a sled.

Conveyance 10 may include a body or frame 14 having a top 16 and an underside 18. A rider may be disposed on the top 16 during use, and system 12 may be disposed substantially between underside 18 and track 2.

Conveyance may include a plurality of wheels, including front wheels and rear wheels 22. Rear wheels 22 may be disposed proximate a rear end of frame 14. Front wheels may be disposed proximate a front end of frame, but preferably, front wheels may be more centrally disposed between front and rear ends.

In this embodiment, speed retarding system 12 preferably acts on rear wheels 22, but a similar system may apply additionally or alternatively to front wheels. System 12 is described here with respect to one of rear wheels 22, and similar components may be used with respect to the other wheels.

Wheel 22 may be coupled to axle 24 via hub 26. Hub 26 may be formed integrally with axle or may be coupled to axle 24 in any manner that prevents hub 26 from moving relative to axle 24 during use. For example, hub 26 may include an opening 28, which may be threaded and sized to receive a fastener 30. Fastener 30 may pass through hub 26 and either into a matching opening in axle 24 or, alternatively, may engage outer surface of axle 24, creating an interference fit between axle 24 and hub 26.

Preferably, conveyance 10 includes separate axles 24 for each of rear wheels 22, which may allow each wheel to rotate independently of the other and at a different speed from the other, e.g., when conveyance 10 moves through a curve. In another embodiment, as seen in FIG. 5, conveyance 110 may include a single axle 124 for each pair of wheels, such as rear wheels 122. In this figure, a single speed retarding system 112 is shown, e.g., substantially centrally disposed between wheels 122. Alternatively, a plurality of speed retarding systems may be disposed along axle 124, e.g., generally symmetrically about a center of axle 124.

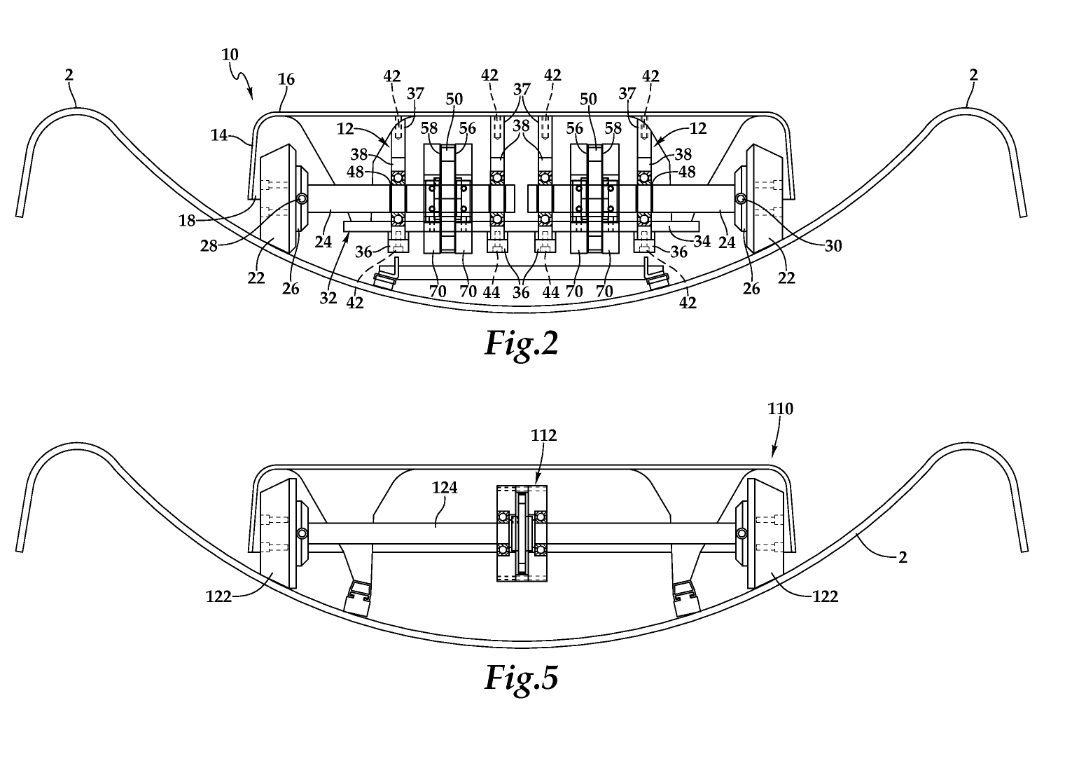

Returning to FIGS. 2-4, speed retarding system 12 may couple to conveyance 10 via mounting bracket 32, preferably at a plurality of locations on conveyance. Mounting bracket 32 may include various components, which may be separate and spaced from each other, coupled together, or formed integrally. Mounting bracket 32 may include a spanning portion 34, which may extend substantially across a width of conveyance 10. Spanning portion 34 may anchor parts of system 12 that do not rotate with wheels 22. In addition, spanning portion 34 may be common to elements of system 12 for each of rear wheels 22, i.e., conveyance may include a single spanning portion 34 for both wheels 22. Spanning portion 34 may be a relatively shallow plate, which may maximize clearance between conveyance 10 and track 2. For example, spanning portion may have a thickness between about ⅛″ and about 1″, preferably between about ¼″ and about ⅝″.

Mounting bracket 32 further may include one or more arms 36. Preferably, mounting bracket 32 includes a plurality of arms 36 for each axle 24, still more preferably, mounting bracket 32 includes two arms 36 for each axle 24.

Arms 36 may be coupled to, may extend rearwardly from, and may be generally perpendicular to, spanning portion 34. A first arm may be disposed proximate the end of axle 24 opposite wheel 22. A second arm may be disposed between first arm and wheel 22, e.g., approximately as equally spaced from rotor 50 (discussed below) as the first arm is.

Staying with FIG. 2, mounting bracket 32 also may include one or more flanges or axle mounts 38. Mounting bracket 32 may include a substantially similar number of arms 36 and axle mounts 38, and each axle mount 38 may extend generally perpendicular to a respective arm 36, e.g., generally upward toward underside 18 of conveyance 10 when in use.

Each axle mount 38 may include an opening 40 disposed laterally through mount 38, i.e., in the same direction as the length of axle 24. Axle 24 may pass through and be supported by opening 40. Bearing 46 may be disposed in opening 40 to facilitate rotation and reduce friction of axle 24. Axle 24 may include a channel 48 at a location aligned with bearing 46, which may cause bearing 46 to overlap radially with an outer diameter of the remainder of axle 24, constraining axle 24 and preventing lateral movement of axle 24 during use. Axle 24 then may be restrained proximate axle mount 38 via one or more retaining rings 49, e.g., one on each side of axle mount 38.

Mounting bracket 32 also may include or be operatively coupled to one or more braces 37. Braces may couple to axle mounts 38 and extend upward toward underside 18 of frame 14. Preferably, a distal end of one or more braces 37 contacts and/or is coupled to frame 14, which may provide added rigidity to mounting bracket 32. Distal end of brace 37 may include a opening 42 configured to receive a fastener, and fastener may be sized and inserted either to bring brace 37 and frame 14 together or to allow for a gap between brace 37 and frame 14, while still keeping those elements coupled.

In one embodiment, mounting bracket 32 may be cast as a single piece. In another embodiment, as shown in the figures, elements of mounting bracket 32 may be coupled together via a plurality of fasteners configured to be received in a plurality of openings. For example, fasteners 44 may be received in openings 42 to couple arms 36 to spanning portion 34. Similarly, fasteners 44 may be received in openings 42 to couple axle mounts 38 to arms 36.

Turning now to FIG. 3, speed retarding system 12 may comprise rotor 50 coupled to, and rotating with, axle 24. Rotor 50 may be substantially cylindrical or disc-shaped, i.e., generally free from eccentricities, to provide for more consistent rotation of axle 24. Rotor 50 may be integrally formed with axle or, alternatively, may include an opening 60 through which axle 24 passes. In the latter case, rotor 50 may be coupled to axle 24 in at least one of a variety of manners, including, e.g., via a key-type connection, through the use of one or more set screws, or via press-fit onto axle 24, i.e., via an interference fit that is loose enough to allow for assembly but tight enough to prevent rotor 50 from moving with respect to axle 24 during use.

Rotor 50 may be between about 2″ and about 6″ in diameter, preferably between about 3″ and about 5″, still more preferably about 4″ in diameter. Rotor 50 may have a thickness between about ¼″ and about 1″, preferably about ½″, although, as with rotor diameter, rotor thickness may be adjusted to allow for a different number, size, and/or thickness of magnets.

Rotor 50 may include a magnetic material, preferably a permanent magnetic material, still more preferably a rare earth magnetic material, e.g., a neodymium magnetic material such as neodymium iron boron (NdFeB) or samarium cobalt (SmCo). Alternatively, other magnets such as aluminum nickel cobalt (AlNiCo) may be used. In one embodiment, substantially all of rotor may comprise the magnetic material.

Preferably, however, rotor 50 may comprise magnetic material 52 interspersed between portions of non-magnetic material 54. Rotor 50 may include a plurality of openings 62, which may be substantially equally circumferentially spaced and which also may be spaced radially substantially the same distance from a center of rotor. In another embodiment, openings may be radially staggered around rotor, or rotor may include a first set of openings at a first radial distance and at least a second set of openings at at least a second radial distance.

Openings 62 may extend inward from one or both of first face 56 and second face 58. Preferably, openings 62 extend completely through rotor 50, from first face 56 to second face 58, although other configurations are possible. For example, openings may extend only partially through rotor on first face 56, and additional openings may extend only partially through rotor on second face 58. In that embodiment, first face openings may overlap or, alternatively, may be circumferentially offset from second face openings.

Returning to the embodiment shown in FIG. 3, in which openings 62 extend from first face 56 to second face 58, magnets 64 may be disposed within openings 62. Each magnet 64 may be substantially similar to the other magnets, i.e., they may be similarly sized and have similar magnetic strength values (i.e., remanence, in the case of permanent magnets). One example of magnets usable with speed retarding system 12 may be Bunting Magnetics N35p500500 magnets, which may be generally cylindrical, with a diameter of about ½″ and a length also of about ½″, as well as a holding power of about 11½ lbs.

Magnets 64 also may be sized to fit substantially flush against first face 56 and second face 58, i.e., magnets 64 may have a thickness substantially equal to rotor thickness. Alternatively, magnets 64 may be embedded slightly with respect to first face 56 and/or second face 58, e.g., up to about 1/16″. Still further, although less preferably, magnets 64 may protrude slightly from first face 56 and/or second face 58, but magnets 64 should not protrude so far as to eliminate gap 76 between rotor 50 and one or more of stators 70 (discussed below).

Circumferentially consecutive magnets 64 may be aligned to have the same polarities. Preferably, however, magnets may be configured to have alternating polarities. For example, as seen in FIG. 4, a magnet having a “north” polarity 66 proximate first face 56 may be surrounded by a plurality of magnets having “south” polarities 68, and vice versa. As such, the system preferably includes an even number of magnets 64 disposed within rotor 50 so that magnets with the same polarities are not adjacent to one another.

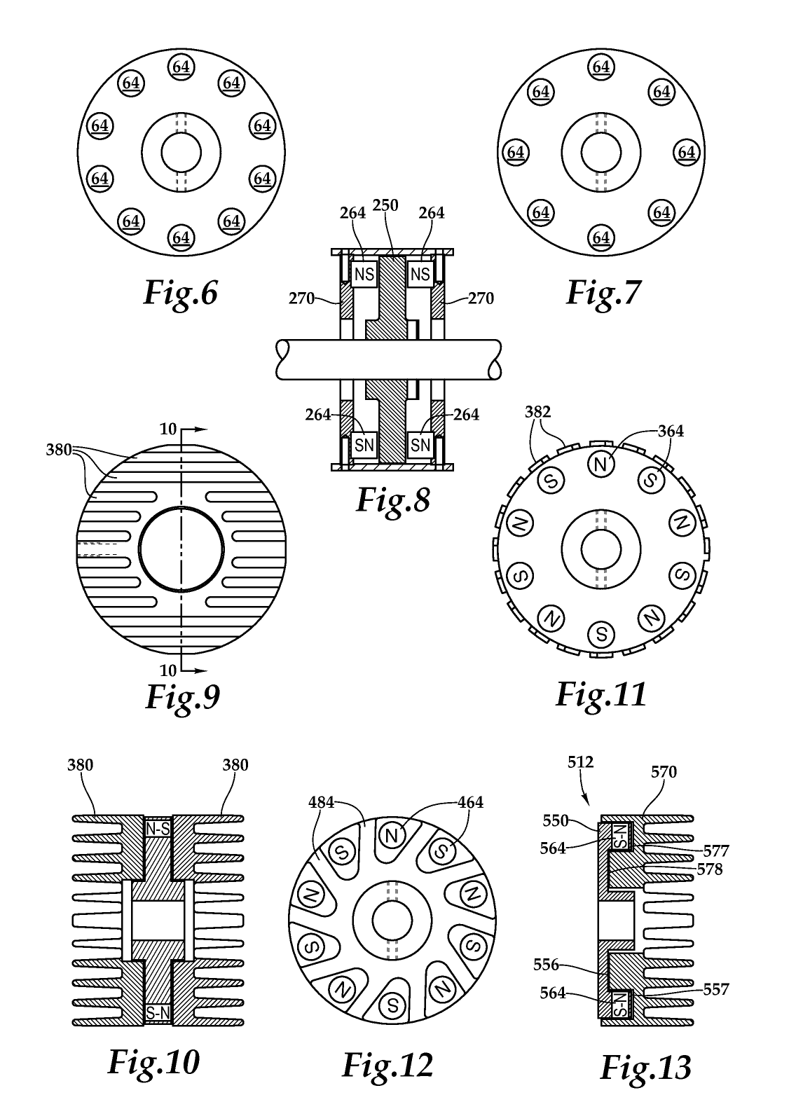

All other things being equal, a greater number of magnets has an increased braking effect. Speed retarding system 12 may include between about 2 and about 20 magnets (although more magnets are possible, depending on the size of the magnets and rotor, the strength of the magnets, and the desired amount of braking force), preferably between about 6 and about 16 magnets, and in one embodiment, about 12 magnets. Other alternative arrangements, having 10 and 8 magnets are shown in FIGS. 6 and 7, respectively.

Returning to FIG. 3, speed retarding system may include at least one stator 70 disposed proximate rotor 50. Preferably, system 12 includes a pair of stators for each rotor; one proximate first face 56 and the other proximate second face 58, and stators may be substantially similar to each other. Stator 70 is configured to remain substantially stationary with respect to rotor 50. In addition, stator 70 may include a face 78 proximate rotor 50 that is substantially planar and substantially parallel to first and/or second face of rotor 50.

Stator 70 may be fixedly coupled to frame 14, either directly or indirectly, e.g., via coupling to mounting bracket 32. In one embodiment, bracket 71 may couple to both mounting bracket 32 and stator 70. Bracket 71 may be generally L-shaped to sit flush against generally perpendicular surfaces of mounting bracket 32 and stator 70. Each of mounting bracket 32, stator 70, and bracket 71 may include openings configured to receive fasteners to couple these elements together. Alternatively, bracket 71 may be integrally formed with one or both of mounting bracket 32 and stator 70

Like axle mounts 38, each stator 70 may include an opening 72 through which axle 24 is disposed. Opening 72 also may include bearing 74 to reduce frictional forces between axle 24 and stator 70.

Stator 70 may extend outward from axle axis at least as much as radial extent of rotor 50 or a furthest radial extent of magnets 64 disposed within rotor 50. Additionally, each stator 70 may be about as thick or, preferably, thicker than rotor 50.

In one embodiment, e.g., rotor may be about ½″ thick and stator may be at least about twice as thick, or about 0.6″.

Additionally, stator 70 may have a radius or height extending downward from axis that is sized to maintain clearance between braking system 12 and track 2. As seen in FIG. 3, stator 70 may not extend about as low as bottoms of arms 36. Clearance in other directions may be as or more important, e.g., stator 70 preferably does not extend rearward beyond a rear end of frame 14. In a forward direction, stator 70 may be sized so as to not interfere with spanning portion 34, although a portion of spanning portion 34 may be removed to provide additional clearance, much like a portion of stator mounting bracket 71 has been removed to provide clearance for stator 70, as seen in FIG. 4. There also preferably is sufficient clearance above stator 70, i.e., between stator 70 and underside 18 of frame 14 to allow for flexion of frame during use.

Stator 70 preferably is a highly conductive, non-magnetic material. In addition, both stator 70 and non-magnetic portions of rotor 50 preferably comprise materials that help dissipate heat, particularly when magnets 64 are rare earth magnets, which tend to have low Curie temperatures, i.e., they can lose their magnetic properties at high temperatures. As such, several choices for rotor 50 and/or stator 70 materials include aluminum, aluminum alloys (including aircraft aluminum), copper, gold, etc. In one embodiment, 6061-T6 aluminum may be used.

In another embodiment, as seen in FIG. 8, instead of rotor 50 containing magnetic material, rotor 250 may comprise a substantially uniform non-magnetic, highly conductive material. Similarly, one or both of stators 270 may contain magnetic material, e.g., each stator 270 may be a magnet. Preferably, stator 270 may be a substantially stationary plate, e.g., having a ferritic backing plate in which magnets 264 are embedded within the stator 270. In this embodiment, if stator comprises one large magnet, that magnet's polarity may be the same or the reverse of the opposing stator. If stator 270 comprises a plurality of magnets 264, adjacent magnets 264 on the same stator 270 may have the same or reversed polarities. Additionally, magnets 264 on opposing sides of rotor 250 may be aligned with or offset from one another, radially and/or circumferentially. In any of these embodiments, magnets may remain substantially stationary with respect to conveyance 10, while rotor 250 rotating past magnets 264 may generate eddy currents and a braking effect.

In order to assist with heat dissipation, one or both of rotor and stators may include fins or other heat dissipating elements, as seen in the various embodiments of FIGS. 9-12. FIG. 9 illustrates an alternative reaction plate, i.e., non-magnetic element, which may be either a rotor or stator. Fins 380 preferably are generally evenly and uniformly distributed over side of reaction plate facing away from magnetic disc. Additionally, fins 380 may extend outward a substantially uniform distance, which may allow for substantially uniform cooling, although fins 380 may extend outward different amounts. For example, radially outward fins may extend a smaller distance than radially inward fins, reducing inertial drag.

FIG. 10 illustrates the alternative reaction plate of FIG. 9 in cross-section with a magnetic disc and a similar, complementary reaction plate opposite the magnetic disc. Fins 380 on the reaction plate may extend around at least one side of the disc, which may provide for convective cooling while minimizing or eliminating disturbances to magnetic fields extending from the disc. Additionally, were magnetic disc not disposed between a plurality of reaction plates, magnetic disc may include fins to extend outward from a side of magnetic disc facing away from reaction plate, i.e., on a side generally opposite magnets 364. In the previous case or in the event the magnetic disc is sandwiched between a plurality of reaction plates, magnetic disc also may include fins 382 such as those shown in FIG. 11, the fins extending generally perpendicular to the axis of rotation.

Still another version of a magnetic disc may be seen in FIG. 12. In this embodiment, the disc may include a plurality of channels 484. Magnets 464 may be disposed alongside channels 484, which may act as impellers to move more air around magnetic disc, aiding in cooling. Alternatively, channels 484 may surround respective magnets 464, e.g., channels may include a plurality of generally linear sidewalls with a curved portion between them. One or both sidewalls may be angled relative to a radius, and the angle of each sidewall may be controlled to direct airflow. Essentially, some of one or more faces of the magnetic disc may be channeled in comparison to another part or parts of the face, which may be comparatively protruding. In the embodiment seen in FIG. 12, magnetic disc may be configured to rotate counter-clockwise, so a leading sidewall may be angled more steeply than a trailing sidewall.

Fins preferably add mass to non-fin versions of rotor 50 and stators 70, as reducing mass may lead to increased heat generation or retention instead of heat dissipation.

Turning now to FIG. 13, yet another embodiment of a speed retarding system 512 is shown. In this embodiment, instead of orienting magnets to have poles generally parallel to axis of rotation, magnets 564 may be disposed with poles generally perpendicular to axis of rotation, e.g., in a generally radial direction. For the sake of convenience, magnetic disc may be considered rotor 550 and reaction plate may be stator 570, but as in the other embodiments, magnetic disc alternatively may be a stator and reaction plate may be a rotor. Here, rotor 550 may include one or more extensions 557 extending away from first face 556 and towards stator 570. Similarly, stator 570 may include one or more channels 577 extending inward from a stator face 578 that are configured to receive extensions 557. Each magnet 564 may extend from its own extension 557, or extension 557 may include a ring having generally constant inner and outer diameters. In either case, channel 577 preferably is a continuous substantially circular groove disposed entirely around stator 570, where channel 577 provides clearance for each extension 557 as rotor 550 rotates about an axis.

Sled may include one or more axles for rear wheels, and one or more speed retarding systems per axle. Speed retarding systems may be substantially similar to one another, or they may differ, e.g., one axle may use the system shown in FIG. 3 while a second axle may use the system shown in FIG. 11.

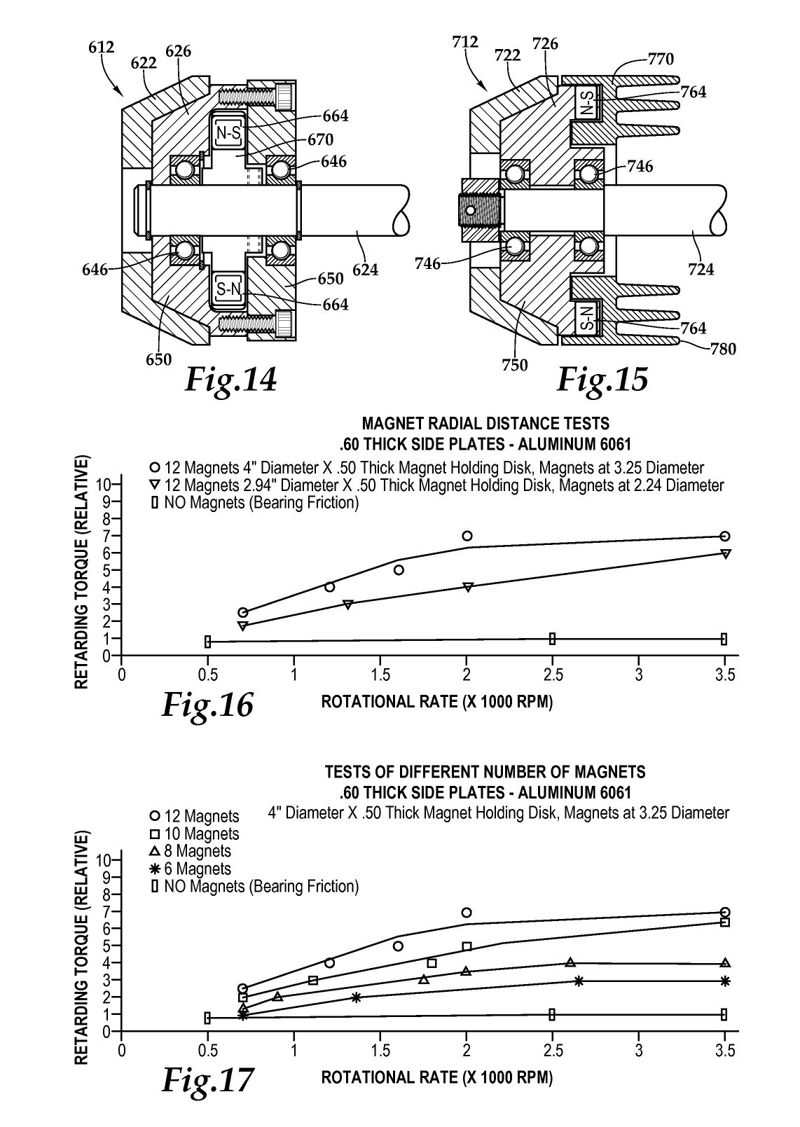

Still other embodiments of a magnetic braking or retarding system may be seen in FIGS. 14 and 15. In FIG. 14, system 612 may be disposed proximate to or formed integral with wheel 622. Hub 626 may comprise and/or be coupled to rotor 650, rotating as wheel 622 rotates. Axle 624 may be rotatably coupled to hub 626, e.g., via bearings 646. In addition, stator 670 may be fixedly coupled to axle 624 so as to not rotate as wheel 622 rotates. Magnetic material 664 dispersal in stator 670 may be similar to the various possible arrangements described above with respect to the embodiment of FIGS. 2-4. Moreover, a second rotor 650 may fixedly couple to hub 622, and also may be rotatably coupled to axle 624, again, e.g., via bearings 646. Additionally, while not shown, one or more of rotors 650 and stator 670 may include fins for heat dissipation.

In the speed retarding system 712 of FIG. 15, magnets 764 may be disposed in hub 722, which may be rotatably coupled to axle 724, e.g., via bearings 746. Like the embodiment of FIG. 13, magnets 764 may be disposed with their poles generally perpendicular to axis of rotation, whereas poles in FIG. 14 may be disposed generally parallel to axis. Stator 770 may be fixedly coupled to axle 724 and may include a groove through which magnets 764 pass. Stator 770 also may include fins 780 to assist with heat dissipation.

Rotation of rotor causes magnets 64, and their corresponding magnetic fields, to move circumferentially past stators 70, which generate induced eddy currents, resisting rotation of rotor 50, leading to a braking or governing action for conveyance 10.

Resistive torques may be affected by several factors, including the size, number, and strength of magnets 64 and the distance between rotor 50 and stators 70. Stronger magnets create larger eddy currents and increased governing. Similarly, larger eddy currents are created when rotor 50 is closer to stators. Preferably, gap is between about 10/1000″ and about ⅛″, still more preferably between about 20/1000″ and about 1/16″, even more preferably between about 25/1000″ and about 40/1000″, and in one embodiment, about 1/32″.

At lower speeds, eddy currents may be significantly lower than at increased speeds, so resistance caused by system 12 may be minimal. Rotational speed of rotor 50 affects resistive torques and forces, i.e., those forces increase with speed increases, as seen in the graphs of FIGS. 16 and 17. This may depart from the principle of operations of some sled hydraulic braking systems, which tend to apply greater forces at lower speeds that diminish as speed increases. Users, however, may not wish to experience significant braking at lower speeds, whereas more braking at increased speeds may be desirable to assist in controlling conveyance 10.

As FIG. 16 shows, retarding torque increases as magnets are moved further away from an axis of rotation. In addition, FIG. 17 illustrates that increasing the number of magnets used increases the retarding torque. In both instances, after subtracting out the retarding torque attributed to bearing friction, it can be seen that retarding torque at high RPMs may be between about 2 times and about 4 times greater than at low RPMs.

Without speed retarding system, wheels 22 on conveyance 10 may reach, e.g., between about 4,000 and about 5,000 rpm. In contrast, a conveyance 10 such as the one seen in FIG. 2, with a system having about twelve neodymium magnets may have a maximum speed restricted to between about 2,500 and about 3,000 rpm, even on straightaway decline portions of track 2. Thus, system 12 also may act as a governor to limit maximum speed of conveyance.

Speed retarding system 12 may overcome many of the drawbacks of mechanical and hydraulic braking systems. For example, with no parts to interface or rub together, system 12 may be substantially wear-free. Additionally, performance of system 12 may be substantially unaffected by water, dirt, and other debris, as eddy currents and resistive magnetic fields may be able to travel through these media and create drag on conveyance.

In addition to eddy current speed retarding system 12, conveyance also may include a mechanical braking system. For example, front wheels may be pivotable and/or translatable with respect to frame 14. A joystick or other control may be coupled to front wheels to change height of front wheels relative to underside 18 of frame 14. At rest, front wheels may be raised so that underside 18 or pads/rails 19 proximate underside 18 contact surface of track 2. The user may release the manual braking mechanism, lowering front wheels so that they contact track 2, and causing separation between underside or pads 19 and track 2. From here, conveyance may progress forward, with speed retarding mechanism taking over, as described above.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A magnetic speed governing device, comprising:
an axle coupled to at least one wheel;
a rotor coupled to said axle and configured to rotate with said axle;
a stator coaxial with said axle and configured to not rotate with said axle; and
a gap between said rotor and said stator;
wherein at least one of said rotor and said stator include a magnetic material;
wherein at least another of said rotor and said stator comprises a non-magnetic, highly conductive material;
wherein said gap is between about 1/32″ and about ⅛″.

2. A device according to claim 1,
wherein said rotor includes said magnetic material.

3. A device according to claim 1,
wherein said magnetic material comprises a plurality of magnets substantially similarly radially spaced from an axis of said axle.

4. A device according to claim 3, wherein said plurality of magnets has alternating polarities.

5. A device according to claim 3, wherein said plurality of magnets extends substantially from one side of said rotor to an opposite side of said rotor.

6. A device according to claim 1, further comprising;
a second stator coaxial with said axle on a side of said rotor opposite from said stator.

7. A device according to claim 1, further comprising:
a second rotor coupled to a second axle, said second axle coupled to a second wheel;
a second stator coaxial with said second axle and configured to not rotate with said second axle;
wherein at least one of said second rotor and said second stator include a magnetic material; and
wherein at least another of said second rotor and said second stator comprises a non-magnetic, highly conductive material.

8. A device according to claim 7, wherein said axle is different than said second axle; and wherein said first wheel is on one side of a conveyance and said second wheel is on an opposite side of said conveyance.

9. A magnetic speed retarding system, comprising:
a rotor rotatable on a shaft, said rotor having a first face and a second face, said faces generally perpendicular to an axis of rotation, said rotor including a plurality of magnets;
a first stationary element generally perpendicular to and spaced a first distance from said first face; and
a second stationary element generally perpendicular to and spaced a second distance from said second face;
wherein said first stationary element and said second stationary element comprise non-magnetic, highly conductive materials;
wherein said first stationary element and said second stationary element each have a radial extent measured from said axis of rotation and greater than a radial extent of said rotor; and
wherein said first distance is substantially equal to said second distance.

10. A magnetic speed retarding system according to claim 9,
wherein said plurality of magnets are substantially equally circumferentially spaced about an axis of rotation.

11. A magnetic speed retarding system according to claim 10,
wherein each of said magnets has a diameter of about ½

12. A magnetic speed retarding system according to claim 9,
wherein said plurality of magnets have alternating polarities.

13. A magnetic speed retarding system according to claim 9,
wherein said plurality of magnets are rare earth magnets.

14. A magnetic speed retarding system according to claim 9,
wherein said plurality of magnets are neodymium magnets.

15. A wheeled conveyance including a magnetic speed retarding system, comprising:
a frame;
a plurality of wheels coupled to at least one axle;
a bracket coupled to said frame for operably coupling said at least one axle to said frame;
a rotor configured to rotate as one of said at least one axles rotates;
a stator operably coupled to said frame and configured to not rotate as said one of said at least one axles rotates; and
a plurality of magnets disposed within said rotor and spaced generally equally circumferentially about an axis of rotation of said rotor;
wherein said magnets are rare earth magnets;
wherein said stator comprises a non-magnetic, highly conductive material; and
wherein said rotor and said stator are separated by an air-filled gap.

16. A conveyance according to claim 15,
wherein said gap has a generally constant thickness.

17. A conveyance according to claim 15,
wherein said gap is generally planar.

18. A conveyance according to claim 15, further comprising:
a second stator operably coupled to said frame, said second stator on a side of said rotor opposite from said first stator;
wherein said plurality of magnets is disposed substantially completely through said rotor.

19. A conveyance according to claim 15, said bracket comprising:
a spanning portion extending width-wise across at least a portion of said frame;
an arm extending generally perpendicular to said spanning portion and generally length-wise across at least a portion of said frame; and
an axle mount extending generally parallel to and away from said arm, said axle mount including an opening through which said one of said at least one axles is disposed;
wherein said stator also is fixedly coupled to said bracket.

20. A conveyance according to claim 15, further comprising:
a mechanical braking system.
